(19) United States
(12) Patent Application Publication
(10) Pub. No.: US 2014/0374457 A1
(43) Pub. Date: Dec. 25, 2014

(54) ADJUSTABLE GAME CONTROLLER NECK SUPPORTER

(71) Applicant: Brian Piccolo, Bothell, WA (US)

(72) Inventor: Brian Piccolo, Bothell, WA (US)

(21) Appl. No.: 14/135,533

(22) Filed: Dec. 19, 2013

Related U.S. Application Data
(60) Provisional application No. 61/739,211, filed on Dec. 19, 2012.

(51) Int. Cl. A63F 13/98; A45F 5/00

(52) U.S. Cl. CPC A63F 13/98; A45F 5/00; A45F 2005/006
USPC 224/600

(57) ABSTRACT

An adjustable neck supporter configured to support a game controller around a player's neck and also and positioned the game controller adjacent to the player's lap when a playing in a sitting or standing position and allows the player to selectively elevate the game control on the neck strap so that the player may walk hands free with the controller in an elevated position and still supported around the player's neck. The neck support includes a length adjustable neck strap that terminates at the user's waist. Attached to the distal end of neck strap is a flexible or rigid bridle that connects to a dual wing shaped game controller with a top control console and two opposite side wings. The bridle attaches to the game controller so the control buttons may be easily manipulated. In one embodiment a strap plate is used to selectively attach the strap to the bridle.

This utility patent application is based upon and claims the filing date benefit of U.S. provisional patent application (Application No. 61/739,211) filed on Dec. 19, 2012.

### COPYRIGHT NOTICE

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

The present invention relates to neck strap holders and more particularly to neck strap holders for game controllers.

2. Description of the Related Art

A game controller is a device used with games or entertainment systems to control a playable character or object on a display. A commonly used game controller is a gamepad, (also known as a joy pad) that requires the use of two hands with the thumbs and fingers used to press action buttons or omni-directional control stick or buttons on the top and sides of the game controller. The action buttons are manipulated with the fingers on one hand, and the omni-directional control stick or buttons are controlled by fingers on the opposite hand.

Wireless game controllers commonly used today include a wireless directional transmitter mounted on its front surface that must be aim at a compatible receiver in the game console. The transmitter lens on the game controller must be exposed and unobstructed in order to operate properly. Most game controllers operate on rechargeable batteries that are coupled to a recharging port mounted on one end of the game controller. Because the recharging port is often connected to a charging station when the game controller is not in use, the recharging port must be accessible.

Serious players often play for several hours. They often move around the room and play while sitting or standing. They often hold other objects such as cell phones, beverages, eat food when playing and occasionally use the rest room. For these activities, the player must set the game controller aside or place the game controller in his or her pocket.

What is needed is a neck strap system for a game controller that enables a player to support a game controller around the neck. Such a system should allow the game controller to be used in a normal manner while sitting or standing, and also allows the player to temporarily reposition the game controller on his or her body to allow them to easily walk around or grasp other objects with the game controller still supported around the player's neck. Such a system should also not interfere with the transmission of the game controller's wireless signal nor interfere with the game controller's recharging port.

### SUMMARY OF THE INVENTION

At the heart of the invention is the discovery that video game players need a neck strap system for supporting a game controller around their neck. When used, the game controller is vertically aligned and positioned near the player's waist so it may be easily grasped and aimed at the game console. Accesses to the game controller's buttons and omni-directional control stick or buttons are also not blocked. The neck strap system includes a bridle that easily attaches to the game controller and does not impede or block transmission of a wireless signal. The bridle may be left on the game controller when not in use and does not prevent charging. During use, the game controller and bridle may be temporarily moved to a higher, elevated location on the neck strap or easily detach the game controller from the neck strap to allow the player to hold other objects or to comfortably walk or move around when playing. When the player wants to resume play, the game controller and bridle may be easily moved back to their original position. The neck supporter also allows the player to easily remove the game controller from the bridle to replace the rechargeable batteries if necessary.

In one embodiment, the bridle includes a main loop strap with a center opening, two parallel end straps and two transverse straps. During assembly, the main loop strap and the two end straps are extended in opposite fore to aft directions over the game controller and the two transverse straps are extended laterally around the game controller. Hook and loop connectors are used to attach the ends of the straps together. Mounted on the main strap are two neck strap hook and loop connectors that connect to the two neck strap sections.

In a second embodiment, a rigid, clip style bridle is used that attaches over the bottom surface of the game controller. The bridle includes two receiving clips that extend upward and snap fit around the lateral surfaces of the game controller's two control arms. The bridle also includes a transversely aligned flat intermediate member that extends under the bottom surface of the game controller. The distal ends of the two neck strap sections attached either directly to the intermediate member or to an optional strap plate that selectively attaches to the intermediate member.

The neck strap, which may be used with both bridles described above, includes two strap sections and an optional neck comfort strap. Attached to the distal ends of the two neck strap sections are hook and loop strips or pads may be interconnected to hold the ends of the two neck strap sections around the player's neck. The optional neck comfort strap may be used between the two neck strap sections to provide additional length or padding for greater comfort. The neck comfort strap may include an elongated hook or loop connector strip to allow greater length adjustment.

Formed on one strap section is a pair of male and female slide connectors to quickly and easily remove the neck strap without readjusting the hook and loop connectors. Also, formed on the outer surface of the strap section is a second hook or loop elongated strip that connects to an optional short extension strap with a male slide connector at one end and a hook or loop pad compatible with the second loop or loop elongated strip on the neck strap section. During use, the player can disconnect the main female slide connector from the main male connector and reattach the female slide connector to the second male slide connector on the short extension strap. This allows the player to temporarily move the game controller to an elevated position so that the player may stop play and move more freely. When desired, the game controller may move back to the original position adjacent to his or her waist.

### BRIEF DESCRIPTION OF THE DRAWINGS

FIG. 1 is a front perspective view of a player sitting and holding a game controller connected to the neck supporter disclosed herein.

FIG. 2 is a front perspective view of a player standing with the game controller connected to the neck supporter and hung near the player's waist and also shows the game controller being attached to secondary connector on the neck strap to temporarily elevate the game controller on the player's body.

FIG. 3 is a side elevational view of a player stand upright with the neck supporter used to support a game controller and showing the game controller at or near the user's waist.

FIG. 4 is a top plan view of the neck supporter attached to a game controller.

FIG. 5 is a bottom plan view of a game control with the bridle attached thereto.

FIG. 6 is a side elevational view of the game controller shown in FIG. 5

FIG. 7 is a front elevational view of the game controller shown in FIGS. 5 and 6.

FIG. 8 is a rear elevational view of a game controller with the bridle attached thereto.

FIG. 9 is a top plan view of the bridle prior to be assembled.

FIG. 10 is a perspective view of the bridle showing how the main, front and side straps are interconnected.

FIG. 11 is a top plan view of a straight neck strap section.

FIG. 12 is a top plan view of a boomerang-shaped neck strap section.

FIG. 13 is a rear perspective view of a game controller with a rigid bridle attached.

FIG. 14 is a side perspective view of the game controller and rigid bridle shown in FIG. 13.

FIG. 15 rear elevational view of the rigid bridle, detachable strap plate and straps.

FIG. 16 is a side elevational view of the rigid bride, detachable strap plate and straps shown in FIG. 15.

FIG. 17 is a front elevational view of the rigid bridle, detachable strap plate and straps.

FIG. 18 is a bottom plan view of the rigid bridle, detachable strap plate and straps shown in FIG. 17.

FIG. 19 is another side perspective view of the game controller and rigid bridle shown in FIGS. 13 and 14.

FIG. 20 is an exploded view of the rigid bridle, detachable strap plate and game controller.

FIG. 21 is a rear elevational view of the rigid bridle.

FIG. 22 is a top plan view of the rigid bridle.

### DETAILED DESCRIPTION OF THE PREFERRED EMBODIMENT(S)

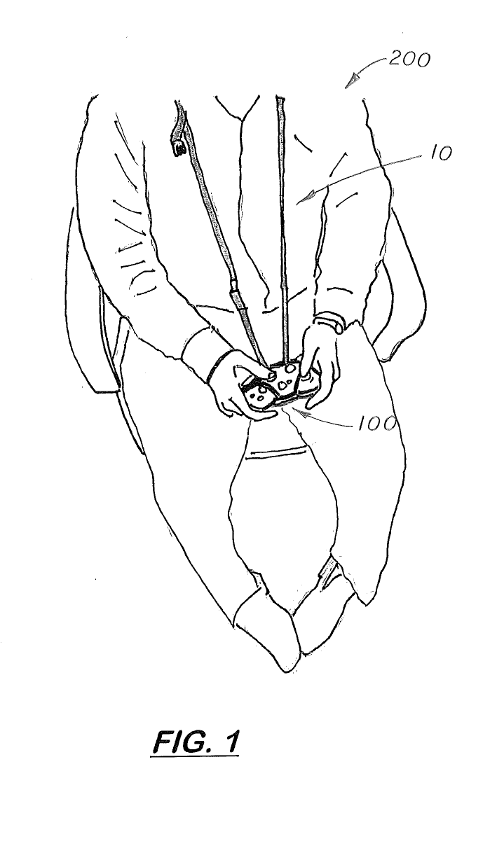

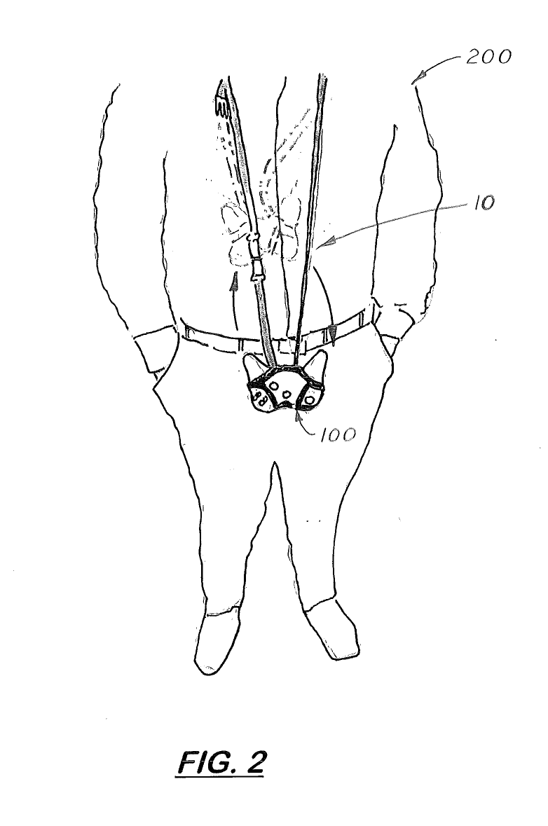

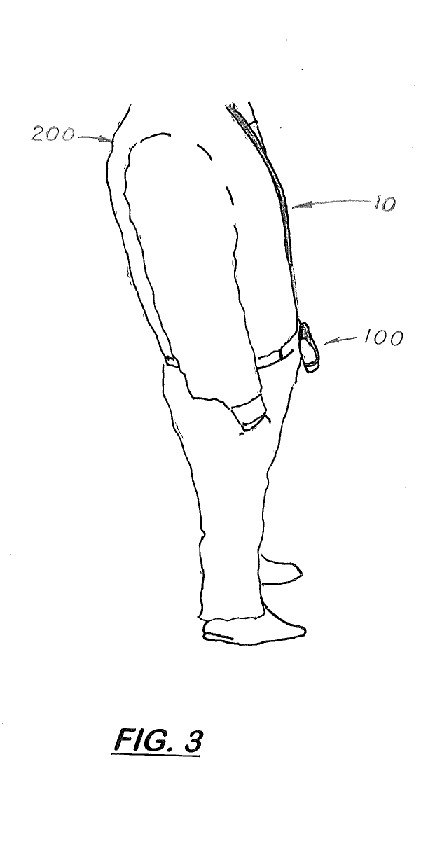

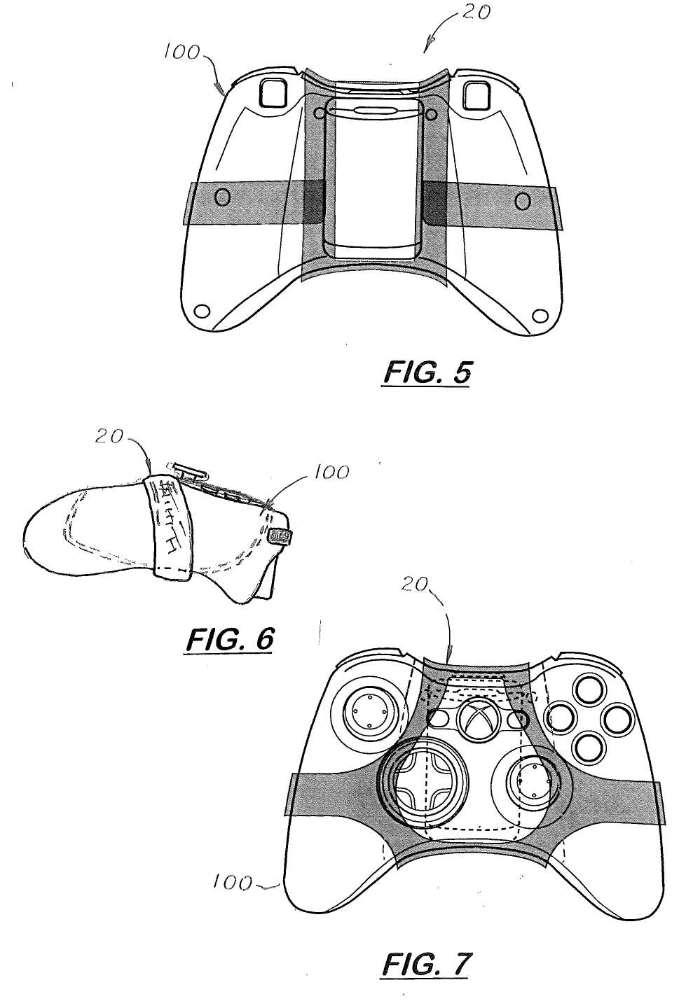

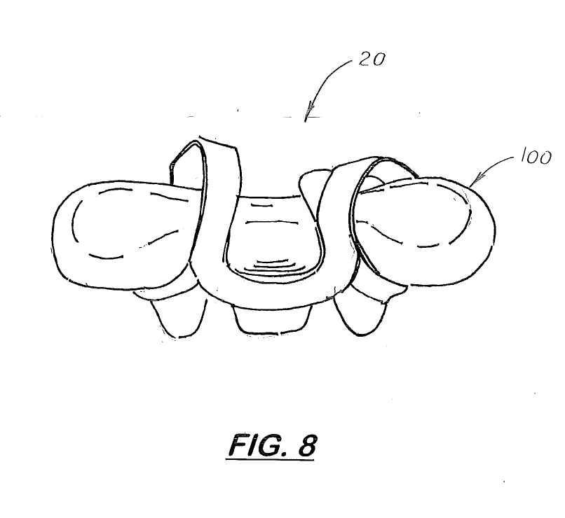

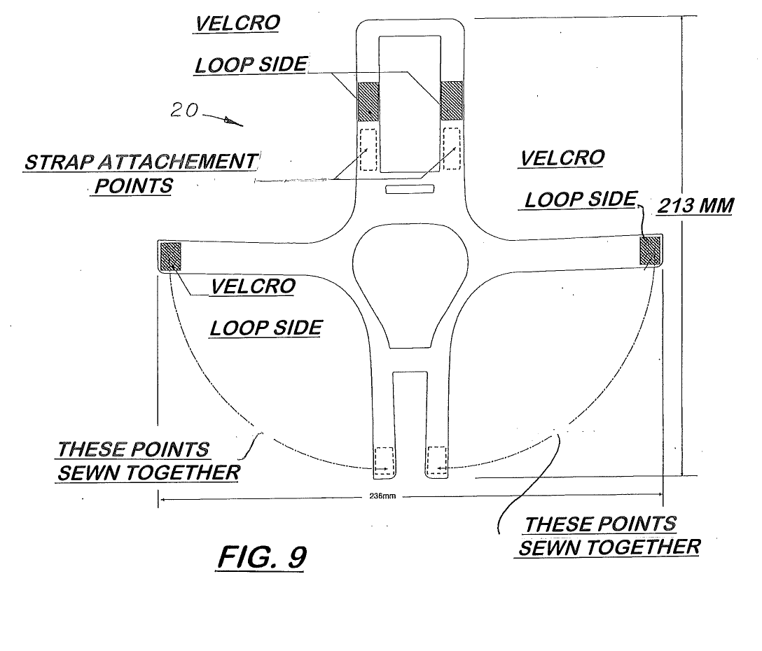

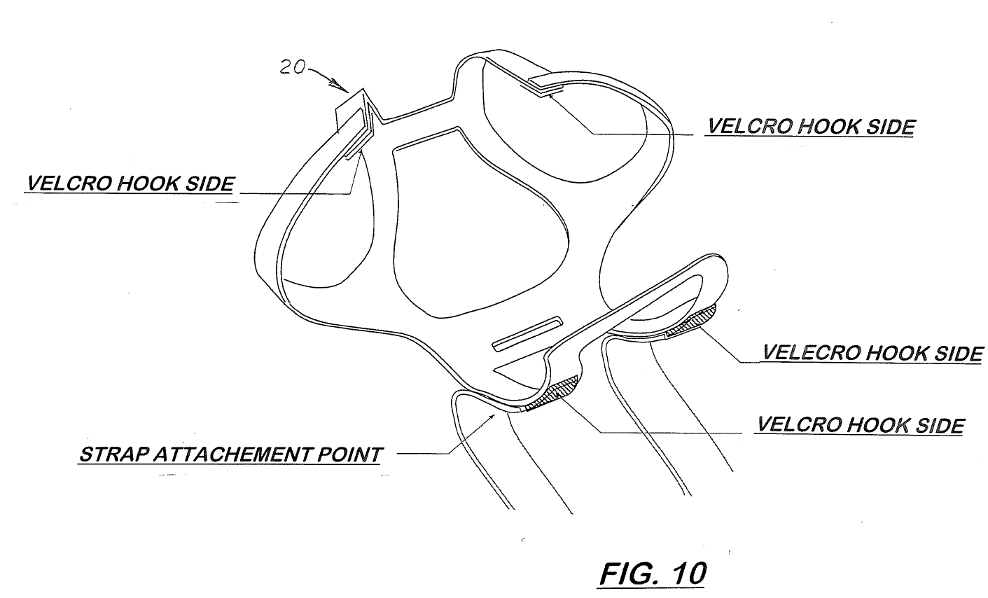

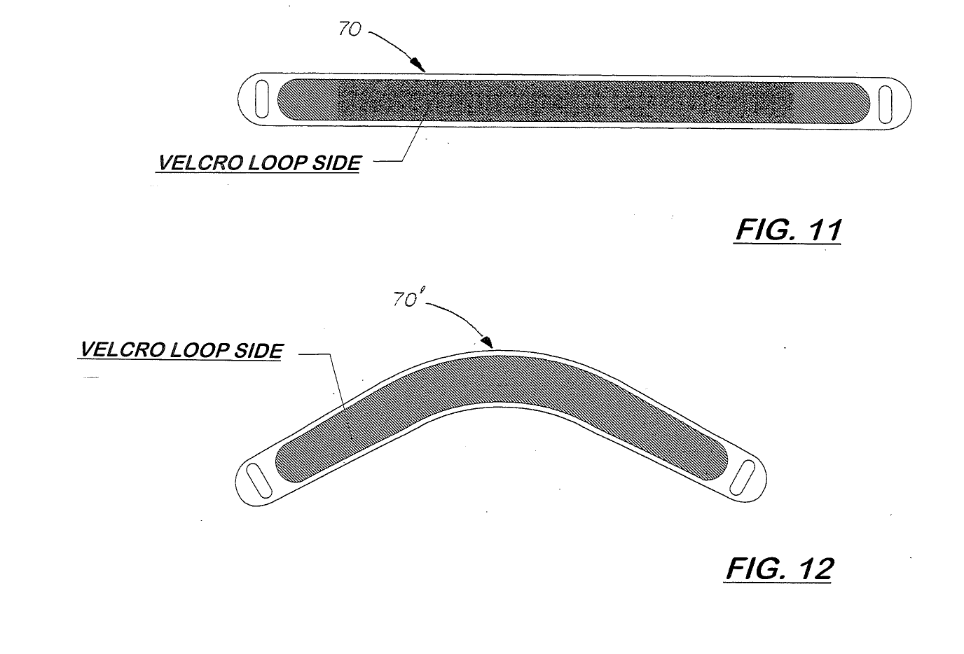

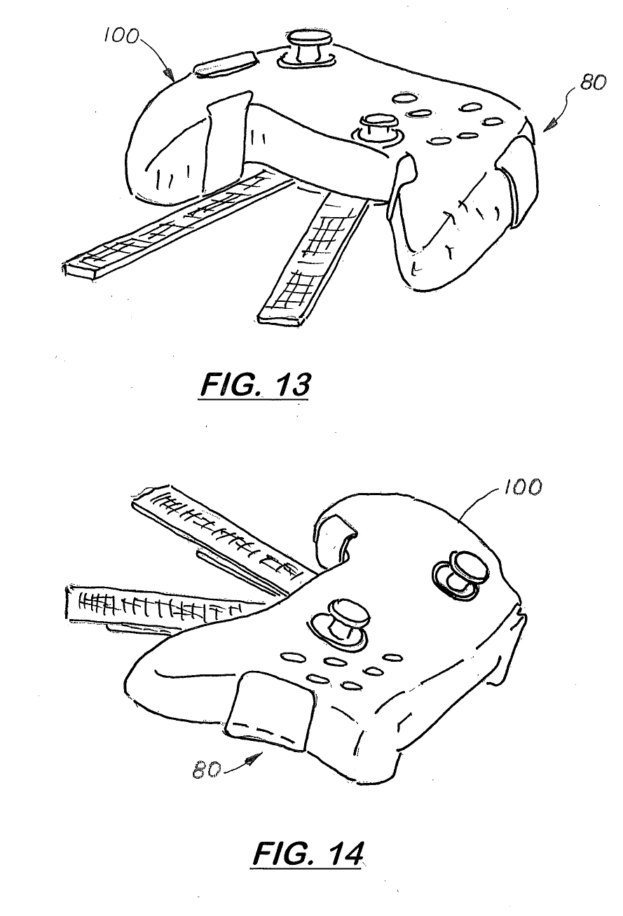

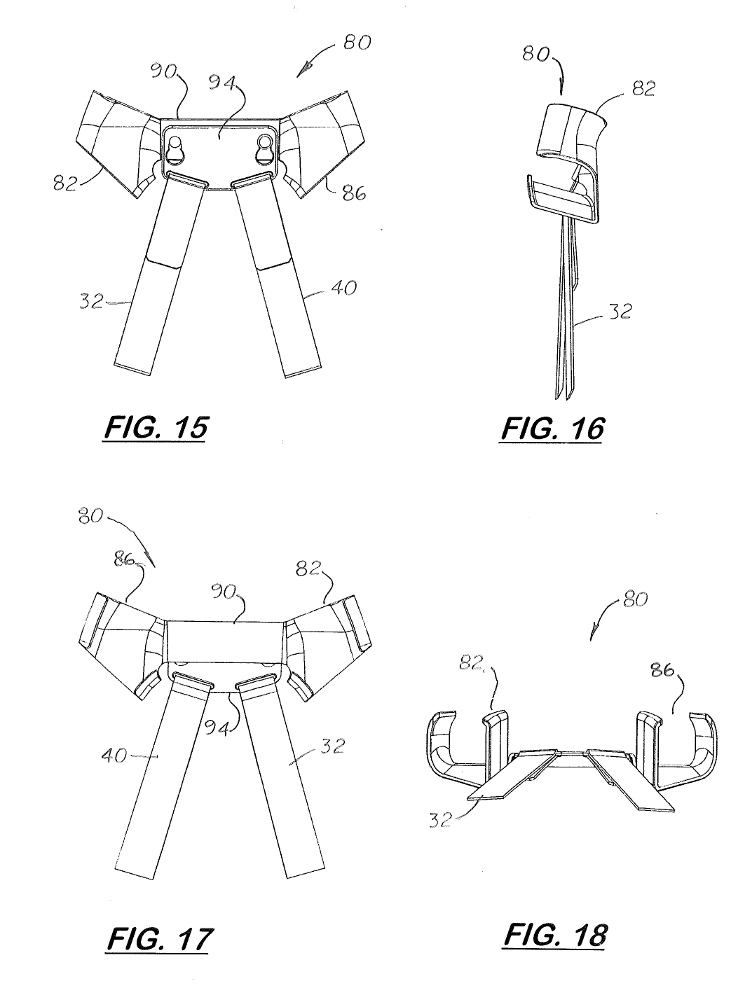

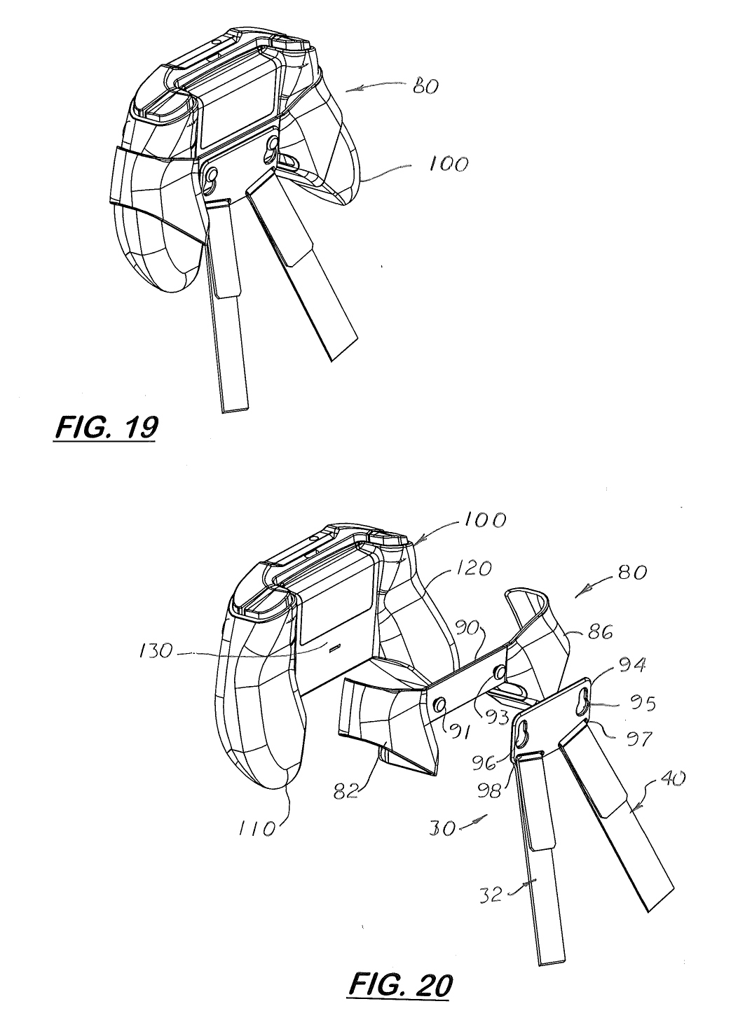

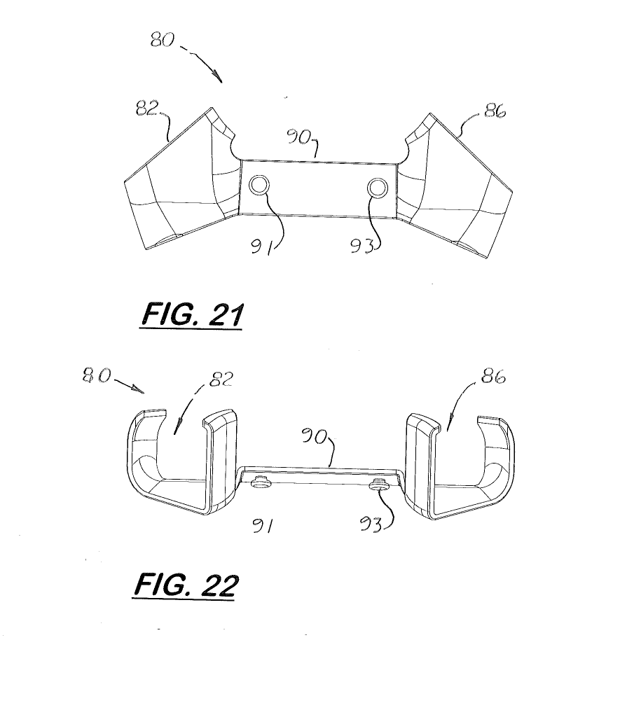

Referring to the accompanying FIGS. 1-22 there is shown several embodiments of an adjustable game controller neck supporter 10, configured to support a game controller 100 around the neck of a player 200. The neck supporter 10 is designed to position a double wing, disc-style game controller 100 with two side control arms 110, 120 and substantially flat bottom 130. Mounted on the top surface of game controller 100 are a plurality of control buttons and an omni-directional control stick that are manipulated by the player's hands. The neck supporter 10 is designed to hold the game controller 100 from its rear edge so it automatically hangs vertically over the player's chest and abdomen. The neck strap 30 is adjustable in length for different size players and for holding the game controller 100 at different elevations when sitting or standing as shown in FIGS. 1, 2 and 3, respectively. The neck supporter 10 also allows the player 200 to easily detach the neck strap from the neck without detaching adjusting more time consuming hook and loop connectors and to temporarily adjust the position of the game controller 100 to an elevated position on the player's chest or side so that the player may walk hands free and without the controller bouncing off the player's waist or lower abdominal region.

The neck supporter 10 includes a length adjustable neck strap 30 attached to one of two bridles, denoted as 30 and 80. Each bridle 30, 80 is configured to surround the game controller 100 without interfering with the touch buttons, the transmitter lens and recharging port.

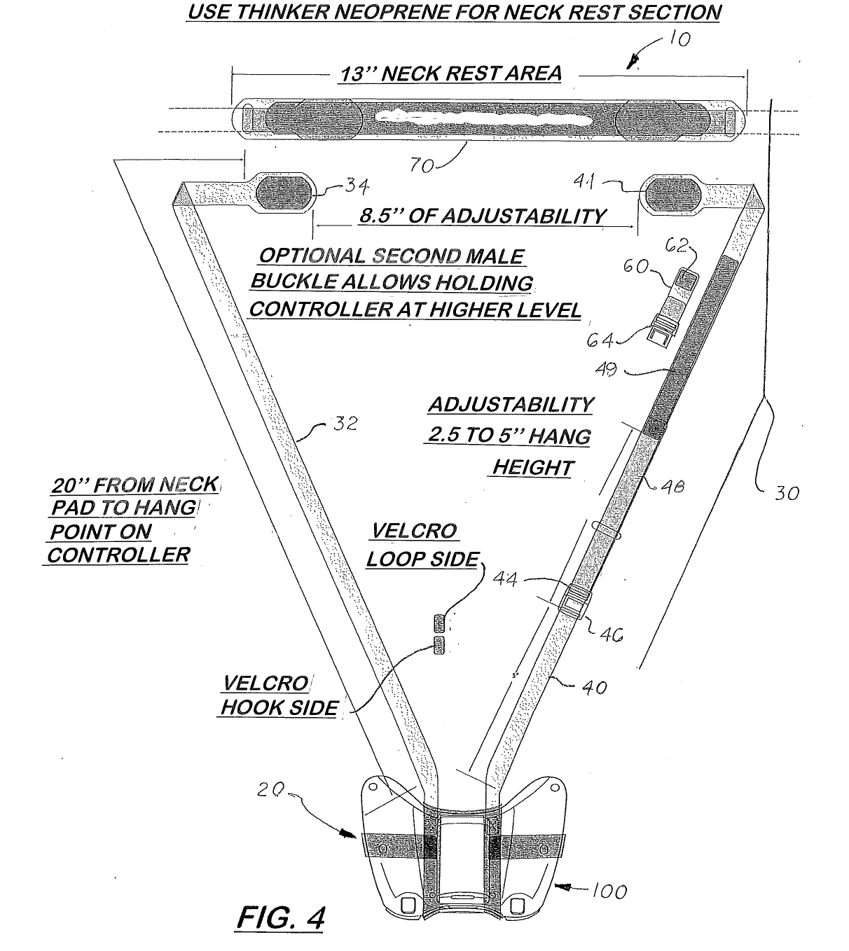

As shown in FIGS. 4-10, the bridle 30 includes a main strap 32 that forms two parallel loops that wrap around controller's wings 110, 120 on opposite sides of the controller's central area. The main strap 32 extends around the controller's rear surface and then loops around the front portion of the battery compartment that extends rearward. The main strap 32 also extends over the game controller's front surface and then rearward over the bottom surface. Attached to the main strap 32 or integrally formed on the main strap 32 are two transverse straps 36, 38 that extend laterally over the game controller 100. Hook and loop connectors 37, 37′ are used to attach the ends of the two transverse straps 36, 38 to compatible hook and loop connectors attached to the free arms on the main strap 32. Also attached to the main strap 32 are hook or loop pads 39, 39′ used to attach to the neck strap sections 32, and 40 discussed further below.

In a second embodiment, the bride 80 is a more rigid, clip style structure with two U-shaped receiving clips 82, 86 that snap fit around the game controller's two control arms, 110, 120, respectively. The bridle 80 includes a transversely aligned, flat intermediate member 90 that extends between the two clips 82, 84 and under the bottom surface 130 of the game controller 100 and securely hold the two clips 82, 84 in fixed position around the two control arms 110, 120. In one embodiment, the distal ends of the two strap sections 32, 40 described further below may attach either directly to the intermediate member 90 or to a strap plate 94 that selectively attaches to the intermediate member 90.

When a strap plate 94 is used, the intermediate member 90 includes two perpendicularly aligned pegs 91, 93 that extend outward from the bottom surface of the game controller 100 when attached to the bridle 80. Each peg 91, 93 include a large diameter head. The strap plate 94 is a flat plate approximately the same length as the intermediate member 90. Formed on the strap plate 94 are two peg slots 95, 96 configured to receive the pegs 91, 93, respectively, and hold the strap plate 94 in a stacked position against the intermediate member 90. Formed on the strap plate 94 are two neck strap section slots 97, 98.

To attach the bridle 80 to the game controller 100, the two control arms on the game controller are aligned and registered over the two clips 82, 84. The game controller 100 is then forced downward causing the two clips 82, 84 to expand and extend around the two control arms.

The neck strap 30, which is designed to be used with both bridles 20, 80, includes two neck strap sections 32, 40. The proximal ends of each neck strap section 32, 40 includes hook or loop connector pads that enable the ends to attached either to the hook or loop connectors on the strap bridle 20 or the rigid bridle 80. Each neck strap section 32, 40 includes additional hook and loop pad connectors that allow the proximal end to fold rearward and interconnect as shown in FIG. 20.

As shown in FIG. 4, the first neck strap section 32 is an elongated structure with a hook or loop pad connector 34 attached as its distal end. The second neck strap section 40 includes a secondary neck strap section 48. Male and female slide connectors 44, 46, respectively are attached to the opposite ends of the neck strap section 50 and the secondary neck strap section 48 that enable them to be selective attached and detached. Attached to the distal end of the secondary neck strap section 48 is a hook or loop pad 41. Mounted or attached to the secondary neck strap section 48 is an elongated hook or loop strip 49.

In the embodiment shown in the Figures, the two distal ends of the two strap sections 32, 40 may be interconnected to hold the neck strap 30 around the neck of the player 200. In addition, a neck comfort strap 70 or 70′ (see FIGS. 4, 11, and 12) may be provided that includes additional padding for greater comfort when placed around the neck. The neck comfort strap 70, 70′ may be made of washable material and may include two optional end slots 72, 74 through which the distal ends of the neck strap sections 32 and 40 may extend. Mounted or attached to the outside surface of the neck comfort strap 70 is a hook or loop elongated pad 76 that engages the hook or loop pads 34, 41 on the distal ends of the neck strap sections 32, 40. Because the distal ends of the neck strap sections may be attached to any location on the hook or loop connector strip 76 on the comfort strap 70, the overall length of the neck strap 30 may be adjusted in length.

Formed on the second neck strap section 40 is a pair of male and female strap connectors 46, 48 that allows the player to easily attach and detach the neck supporter and a buckle that allows the player to adjust its overall length after the first neck strap section 30 has been adjusted.

Formed on the outer surface of the second segment 48 on the second next section 40 and above the first male slide connector 44 is a second hook or loop elongated strip 49. Attached the elongated strip 49 is an optional short extension strap 60 with a male slide connector 64 at one end. Attached to the upper end of the extension strap is a hook or loop pad 62 compatible with the second loop or loop elongated strip 49 on the strap section 48. During use, the player 200 can disconnect the main female slide connector 46 from the main male connector 44 on the neck strap 40 and reattach the female slide connector 46 to the second male slide connector 64 on the short strap 60. The hook or loop pad 62 on the short extension strap 60 is then attached anywhere along the second hook or loop elongated strip to raise and elevate the bridle 20 or 80 and the game controller 100 over the player's chest so that the player 200 may walk hands free and without the controller bouncing off the player's waist or lap.

The bridle 80 may be made of any rigid, elastic material that supports the game controller 100 and enables the clips to bend outward and snap fit back to an original position hold the game controller 100. After the bridle 80 has been attached to the game controller 200, the proximal ends of the first and second neck strap 32, 40 are then extended through slots formed on the intermediate member or on the strap plate. Hook and look pad connectors on the ends of the first and second neck strap sections 32, 40 are then interconnected to hold the neck sections 32, 40.

In compliance with the statute, the invention has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. An adjustable game controller neck supporter, comprising;
a. a bridle configured to wrap around a game controller with its action buttons and transmitter exposed;
b. a length adjustable neck strap that extends around the user's neck and terminates at the user's waste;
c. a primary strap connector attached to the bridle to temporarily attach the bridle to the neck strap; and,
d. a secondary strap connector attached at an elevated position on said neck strap, the secondary strap connector being configured to temporarily connect to the bridle and the game controller at an elevated position on the player's chest.

2. An adjustable neck supporter for a game control with two opposite control arms and a center body, comprising;
a. a bridle positioned over the bottom surface of a game controller, said bridle includes two receiving clips, each said clip configured extend around a control arm on said game controller to connect said bridle to said game controller;
b. an intermediate member extending between said clips and extending under said game controller when said game controller is attached to said receiving clips;
c. a first and second neck strap sections coupled to said intermediate member, each said first and second neck strap sections including compatible hook or loop connectors that enable said first and second neck strap sections to be selectively connected together, said second neck strap including a male and female slide connector that enable said second neck strap to be disconnected; and,
d. a short extension strap attached at an elevated position on said second neck strap above said male and female slide connector, said short extension strap includes a male or female slide connector that is compatible and configured to be selectively connected to the lower said male or female slide connector on said lower segment of said second neck strap thereby enabling said bridle to be held in an elevated position on said second neck strap.

3. The neck supporter as recited in claim 1, further including a strap plate disposed between said intermediate member and said first and second neck strap sections.

4. The neck supporter as recited claim 3 wherein said intermediate member includes at least two pegs and said strap plate include two compatible peg slots.

5. The neck supporter as recited in claim 2, wherein said bridle is made of plastic.
